(19) United States
(12) Patent Application Publication
(10) Pub. No.: US 2023/0321851 A1
(43) Pub. Date: Oct. 12, 2023

(54) Illuminated Tool Device

(71) Applicants: Richard Porter, Wisconsin Dells, WI (US); Bradley Booth, Mazomanie, WI (US)

(72) Inventors: Richard Porter, Wisconsin Dells, WI (US); Bradley Booth, Mazomanie, WI (US)

(21) Appl. No.: 18/063,105

(22) Filed: Dec. 8, 2022

Related U.S. Application Data
(60) Provisional application No. 63/322,831, filed on Mar. 23, 2022.

(51) Int. Cl. B26B 11/00; B26B 5/00

(52) U.S. Cl. CPC B26B 11/008; B26B 5/003

(57) ABSTRACT

The present invention relates to improvements in the field of tools, such as utility knives. The tool features a battery powered illumination element that allows the user to illuminate the working surface and working edge. This enhances working with a tool or utility knife in conditions where there is inadequate light. The user can press a button on the handle to activate or deactivate the light without deploying the blade, and the batteries that power the light may be replaced or recharged as needed.

### CROSS-REFERENCE TO RELATED APPLICATION

The present application claims priority to, and the benefit of, U.S. Provisional Application No. 63/322,831, which was filed on Mar. 23, 2022, and is incorporated herein by reference in its entirety.

### FIELD OF THE INVENTION

The present invention relates generally to the field of utility knives and other precision tools having a working edge. Specifically, the present invention is a tool, such as a utility knife, that features a battery powered LED light to allow the user to easily view where and what he or she is working on in low light or dimly lit areas. Accordingly, the present disclosure makes specific reference thereto. Nonetheless, it is to be appreciated that aspects of the present invention are also equally applicable to other like applications, devices, and methods of manufacture.

### BACKGROUND

By way of background, using a utility knife in the dark or in other low light conditions can oftentimes result in inaccurate cuts and wasted materials, both of which are undesirable. Additionally, an individual using a utility knife with one hand while holding a flashlight with the other hand may have difficulty keeping their cutting surface and material stable. As a result, serious injury can occur if a person using the knife is not completely focused on the task at hand.

Therefore, there exists a long-felt need in the art for a tool that allows users to illuminate a working surface to provide for a safer and more accurate cut. There is also a long-felt need in the art for a tool handle with an LED light that can be illuminated without deploying the working edge of the tool. Finally, there is a long-felt need in the art for a LED illuminated tool that is battery operated.

The present invention overcomes the forgoing problems and is comprised of a handle for gripping the tool and a battery powered LED light that allows the user to illuminate the work surface and the working end of the tool, such as but not limited to a blade of a knife or other working end of a tool. During use in a dimly lit setting, a user can press a button on the handle of the tool to activate or deactivate the LED light without deploying the working edge of the tool, such as but not limited to a blade. The blade can be replaced via a fastener within the handle. The blade can be released and replaced so an individual can utilize the tool or knife as needed. The light maximizes accuracy and safety while performing various tasks, such as but not limited to cutting or removing debris from various surfaces and materials, which eliminates the need to use one hand to operate a tool and use the other hand to hold a flashlight or other light source.

Specifically, the tool has a working edge such as a blade on utility knife, screwdriver, chisel or the like, that features a battery-operated light to illuminate the cutting or working surface and therefore, offers a safer work experience for the user. The LED light can be switched on and off without deploying the blade or working edge via a power button on the handle of the tool. The working edge of the tool, such as a blade of a utility knife, is fully retractable via a slider on the top surface of the handle. This blade can be removed or replaced via a fastener disposed on the handle. A screwdriver may be used to loosen and remove the fastener that holds the blade in place on the side of the handle. The batteries used to power the LED light are stored within a receptacle in the handle, wherein the receptacle comprises a removable cover so the batteries can be easily replaced or recharged.

The subject matter disclosed and claimed herein, in one embodiment thereof, is comprised of an illuminated tool device. The device is designed to provide a safer and more accurate working experience. The illumination source, such as an LED light, is battery operated and can be activated or deactivated via a power button on the side of the device handle without deploying the blade or working edge. The blade may be fully retractable via a slider on the top surface of the handle or may be a fixed blade. In either fixed or retractable embodiment, the blade may be removed or replaced via a mechanism located on the side of the handle.

In this manner, the device accomplishes all of the foregoing objectives and provides users with a tool that is safe, accurate, and effective in providing illumination. The device is particularly useful to users working in unfavorable lighting conditions, as it eliminates the need to hold a flashlight while cutting or performing other tasks on a workpiece.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an illuminated tool device. The tool is preferably a specialized utility tool comprised of a handle and a working edge and a battery powered illumination source such as but not limited to an LED light that allows a user to easily view lowlight working areas. The light can be turned on/off without using the working end of the tool, and the battery may be replaced or recharged as needed. The working edge, or end of the tool can be replaced via a fastener disposed on or within the handle. The working edge can be released and reinstalled so a user can utilize the tool as needed. The light maximizes accuracy and safety while cutting various surfaces and materials.

In one embodiment, the handle of the LED light utility knife is manufactured from a rigid plastic such as polystyrene or polyester or a metal such as aluminum or galvanized steel. The handle may be comprised of a grip area that may be rubberized and have finger grooves for a more ergonomic design, allowing for a more secure grip of the tool. In a differing embodiment, the handle of the LED light utility knife is manufactured from metal, heat-sealable plastic or polymer, such as polypropylene or acrylonitrile-butadiene-styrene (ABS), or any material known in the art deemed suitable for the described purpose. A power button located on the handle preferably operates the illumination. The power button may itself be illuminated when the light source itself is illuminated.

A blade slider is used to deploy or retract the blade or working edge and is located on the top surface of the tool or handle. The blade slider may be locked into place either in the fully deployed or fully retracted position. The slider may be comprised of ridges that provide a more stable grip while sliding the blade in or out. In one embodiment, the blade slider must first be depressed inward before sliding. This feature adds an extra level of safety and may prevent children from deploying the blade or the blade being accidentally deployed.

In one embodiment, the fastener is activated by the use of a screwdriver or other tool to release the fastener holding the blade or working edge in place, allowing the blade or working edge to be removed or replaced as needed. Said fastener may be located on one side of the handle. The head of the fastener may be a flat head screw or any other fastener type.

The light source may be located on the handle just below the blade or working edge. This location allows for illumination of not only the work surface, but of the working edge for added safety during use. In one embodiment, the tool has battery compartment located on the side of the handle of the tool or utility knife, allowing for quick and easy access. The compartment may be comprised of a battery door.

In one embodiment, the tool or utility knife features a blade or working edge cover for added safety. The blade cover may be manufactured from plastic, but any material seen in the art deemed suitable for the purpose described may be used. The blade or working edge of the illumination tool or utility knife is preferably a traditional steel utility knife blade. The blade may be dual ended so that when the first side becomes dull, the blade may be flipped to reveal the sharp blade edge on the opposing side, reducing the need for replacement of the blade. In one embodiment, the blade is fully deployable or retractable via the blade slider or is fixed in a single use position.

The exact size, measurement, construction, and design specifications of the illumination tool or utility knife handle may vary upon further development and manufacturing. Further, numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the illuminated tool device depicting both sides of the device in accordance with the disclosed architecture;

FIG. 2 illustrates a perspective view of one potential embodiment of the illuminated tool device, depicting the illumination function of the device upon actuation of the power button in accordance with the disclosed architecture;

FIG. 3 illustrates a perspective view of one potential embodiment of the illuminated tool device of the present invention being used in dimly lit conditions to cut open a box with the light illuminated in accordance with the disclosed architecture;

FIG. 4 illustrates a perspective view of the battery replacement mechanism of one potential embodiment of the illuminated tool device of the present invention in accordance with the disclosed architecture, as well as a cover being placed over the knife for protection while not in use;

FIG. 5 illustrates a perspective view of one potential embodiment of the blade or working edge replacement mechanism of the illuminate tool device of the present invention in accordance with the disclosed architecture, wherein a screwdriver is used to loosen and remove the screw on the side of the LED utility knife in order to remove or replace the blade; and

FIG. 6 illustrates one potential embodiment of a kit for use in retrofitting a tool with an illumination element in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a tool that allows users to illuminate a cutting or working surface to provide for a safer and more accurate experience. There is also a long-felt need in the art for a tool with a light source that can be illuminated without deploying the blade or working edge. Finally, there is a long-felt need in the art for an illumination element combined with a tool that is battery operated.

The present invention, in one exemplary embodiment, is comprised of a illuminated tool device. The tool is comprised of a light source, such as but not limited to an LED light, that allows a user to illuminate the cutting or working surface and blade or working edge of the tool. This invention is generally desired in the art to make the experience of working with a versatile tool which has a working edge or utility knife safer, especially in conditions where there is inadequate lighting, or the working surface is difficult to see, such as where the surface is fabric or the surface is covered with debris, when performing the working such as cutting. While working in a dimly lit setting, the user can press a button on the handle to activate or deactivate the LED light without deploying the blade or working edge. The blade or working edge can be replaced via a fastener implemented within the handle. The blade or working edge is released and reinstalled so an individual can utilize the knife or working edge as needed. The light maximizes the accuracy and safety while working on or cutting various surfaces and materials, eliminating the need to use one hand to operate a tool, such as a utility knife, and the other hand to hold a flashlight or direct a light source to the point of the working edge.

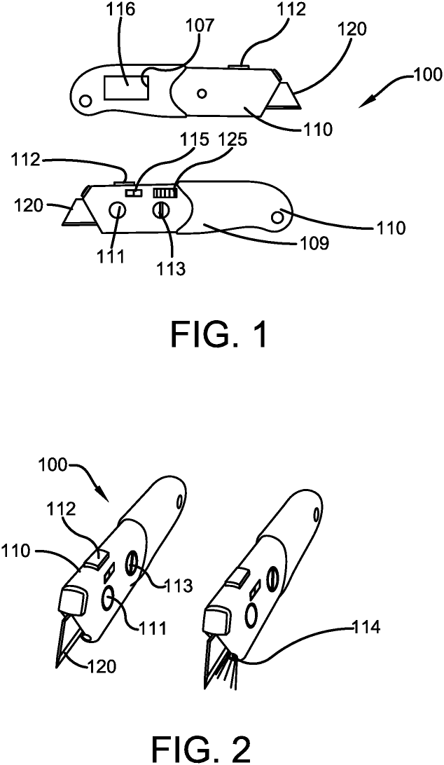

Referring initially to the drawings, FIG. 1 illustrates a perspective view of one embodiment of the tool 100, depicting both sides of the housing 109. In the present embodiment, the tool 100 is an improved tool or utility knife that maximizes accuracy and safety. The tool 100 is particularly designed to allow an individual to use the tool in dimly lit conditions, eliminating the need to hold the tool in one hand and a flashlight in the other hand while cutting or performing work on a surface. More specifically, the tool 100 generally comprises a housing 109 which forms a handle 110, and at least one blade 120. The housing 109 includes a cavity in which the blade 120 or other working edge may be stored. The housing 109 and/or handle 110 may also be produced with an antimicrobial material so that if the tool is used by multiple individuals, germs and bacterial will not be transferred from individual to individual.

In one embodiment, the handle 110 has at least one power button 111, at least one blade slider 112, at least one fastener 113, at least one illumination element such as but not limited to a LED light 114, at least one battery compartment 107, and at least one battery cover 116.

In one embodiment, the power button 111 is located on a side of the handle 110 and is used to turn the illumination element 114 on or off. The power button 111 can be actuated without deploying the blade 120. The power button 111 may have a selection feature 115 to allow the user to choose between a wide beam or narrow beam in order to focus the light emitting from the illumination element.

The handle 110 may be manufactured from heat-sealable plastic or polymer, such as polypropylene or acrylonitrile-butadiene-styrene (ABS), aluminum, stainless steel, galvanized steel, or any other material or combination thereof deemed suitable for the purpose described.

FIG. 2 illustrates a perspective view of one embodiment of the tool 100, depicting the illumination function of the lighting element such as a LED light 114 upon actuation of the power button 111. FIG. 2 depicts the LED light utility knife 100 in both illuminated conditions with the LED light 114 deactivated, and dim conditions with the LED light 114 activated.

In one embodiment, the LED light 114 is located on the housing 109 just below the blade or working edge 120. This location allows for illumination of both the cutting surface and the blade 120 which provides a more accurate and safe experience during use.

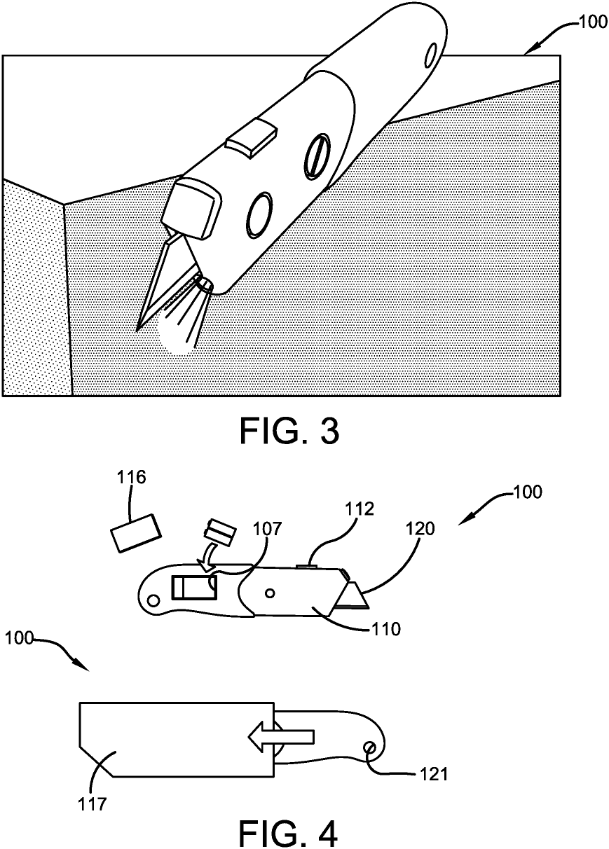

FIG. 3 illustrates a perspective view of the tool 100 being used in dimly lit conditions to cut open a box with the light 114 illuminated, and wherein the blade slider 112 in the fully actuated position having fully deployed the blade 120. The tool 100 may also have a blade in a permanently fixed position which would not require the working edge to be retracted or placed in an operating position. The blade slider 112 has a locking mechanism that allows the user to lock the blade 120 or working edge in a fully deployed or fully retracted position for an added level of safety.

FIG. 4 illustrates a perspective view of batteries being placed into the battery compartment 107, and battery cover 116 of the light 100 of the present invention in accordance with the disclosed specification. This figure also depicts at least one knife cover 117 being placed over the knife for extra protection while not in use. Further, at least one eyelet 121 may be used to hang the tool or knife from a hook or key chain.

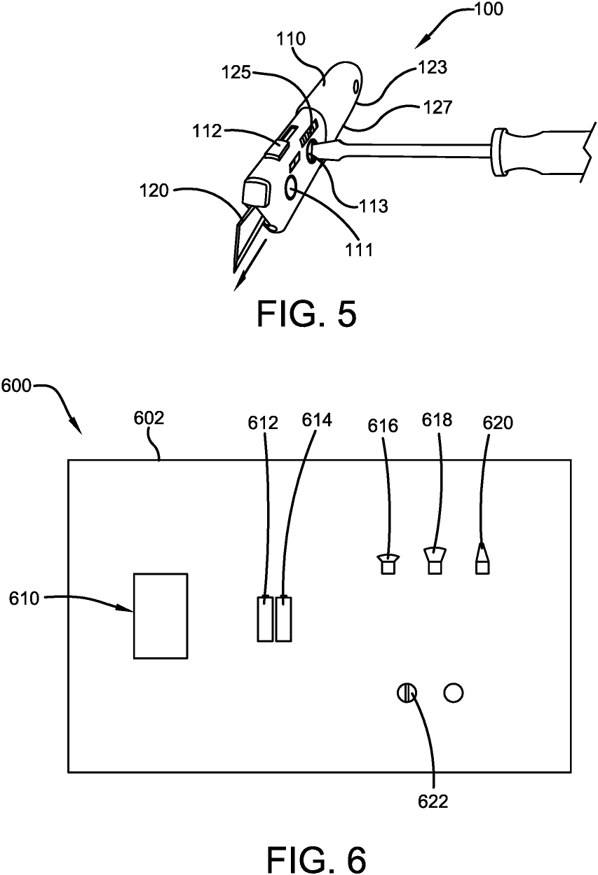

FIG. 5 illustrates a perspective view of one embodiment of the blade replacement mechanism of the tool 100 of the present invention. A screwdriver or other flat tool is used to actuate the fastener 113, loosening and removing the fastener 113 (such as but not limited to a screw) on the side of the handle 110 of the LED utility knife 100 in order to remove or replace the blade 120. FIG. 5 also shows the grip area 123 which may be a ribbed, rubberized area to help in holding the tool. The grip area may also have finger areas 127 to improve the grip on the tool 100. A usage indicator 125 also provides a counter so that the individual can count the number of times the working edge or blade has been used so as to signal time to change the working edge or blade.

FIG. 6 provides a kit 600 which includes a package 602 which is suitable for retail or online sales. The kit 600 includes a housing 610 for holding one or more batteries 612, 614. The kit further includes different illumination elements 616, 618, 620 to allow the user to select different lights that may be used with the tool or utility knife. The illumination elements may provide one of a wide or narrow light beam, different colored light, UV light so that the light may be used to highlight a line which may be traced on the material. The kit also includes an attachment feature 622 which may be an adhesive, magnet, clip, hook and loop or combinations thereof.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “LED light utility knife”, “tool”, “tool or utility knife”, “illuminated tool or utility knife”, and “device” are interchangeable and refer to the LED light utility knife 100 of the present invention.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tool comprising:
a working edge;
a housing having a cavity sized and configured to hold the working edge;
a handle positioned on the housing, wherein the handle is comprised of a grip area and an activation button; and
an illumination element provided on the housing for illuminating a working area when the activation button is engaged.

2. The tool as recited in claim 1, wherein the grip area comprises a rubberized area.

3. The tool as recited in claim 1, wherein the grip area comprises a plurality of finger areas to improve holding of the tool.

4. The tool as recited in claim 1, wherein the illumination element projects a wide or narrow light beam, a different colored light, or a UV light.

5. The tool as recited in claim 1, wherein the housing is comprised of an antimicrobial material.

6. The tool as recited in claim 1, wherein the handle is comprised of an antimicrobial material.

7. The tool as recited in claim 1 further comprising a battery and a usage indicator.

8. The tool as recited in claim 1, wherein the housing comprises an eyelet for holding the tool.

9. The tool as recited in claim 1, wherein the activation button comprises a selection feature to allow changing of a light beam from the illumination element.

10. The tool as recited in claim 1, wherein the housing further comprises a blade slider for moving the working edge into and out of the housing.

11. The tool as recited in claim 1, wherein the tool is a utility knife.

12. A utility knife comprising:
a housing comprised of a handle and a battery compartment;
a blade;
a gripping area disposed of on the handle;
an illumination element disposed of on the housing;
a blade slider disposed of on the housing for repositioning the blade relative to the housing; and
an activation button for activating the illumination element.

13. The utility knife as recited in claim 12, wherein the gripping area comprises a rubberized ribbed area.

14. The utility knife as recited in claim 12, wherein the activation button comprises a selection feature to allow changing of a light beam emanating from the illumination element.

15. The utility knife as recited in claim 12, wherein the selection feature allows for selection of at least one of a wide light beam, a narrow light beam, a colored light, or a UV light.

16. The utility knife as recited in claim 12, wherein the housing comprises a usage guide.

17. The utility knife as recited in claim 12, wherein the housing comprises an eyelet and an antimicrobial material.

18. The utility knife as recited in claim 12, wherein the gripping area comprises a plurality of finger areas.

19. A kit for retrofitting a tool, the kit comprising:
a package;
a battery housing;
at least one battery;
an attachment feature; and
at least one illumination element.

20. The kit as recited in claim 19, wherein the illumination element projects a wide light beam, a narrow light beam, a first colored light, a second colored light and a UV light as chosen by a user via a selection feature.
